(19) United States
(12) Patent Application Publication
(10) Pub. No.: US 2019/0317682 A1
(43) Pub. Date: Oct. 17, 2019

(54) METRICS DRIVEN EXPANSION OF CAPACITY IN SOLID STATE STORAGE SYSTEMS

(71) Applicant: EMC IP HOLDING COMPANY LLC, Hopkinton, MA (US)

(72) Inventors: Jun Li, San Jose, CA (US); Adnan Sahin, Needham, MA (US); James M. Guyer, Northboro, MA (US); Stephen R. Ives, West Boylston, MA (US)

(21) Appl. No.: 15/950,805

(22) Filed: Apr. 11, 2018

(51) Int. Cl. G06F 3/06; G06F 12/02; G06F 11/30; G06F 11/34

(52) U.S. Cl. CPC G06F 3/0631; G06F 3/0647; G06F 3/064; G06F 11/3442; G06F 3/0689; G06F 12/023; G06F 11/3034; G06F 3/061

(57) ABSTRACT

The system, devices, and methods disclosed herein relate to using historic data storage system utilization metrics to automate data expansion capacity. In some embodiments, the data storage system is a RAID cloud having a plurality of storage devices divided into logical slices, also called splits. Methods disclosed herein allow user defined thresholds to be set wherein the thresholds control when data storage will be expanded. Data storage expansion capacity can be based upon historic usage criteria or customer-based criteria. Additional system customizations include user control over rebalancing data distribution as well as determining when system performance should be routinely evaluated offline.

### FIELD OF THE INVENTION

This disclosure is related to the field of data storage and, more particularly, to systems and methods automating storage capacity expansion by relying upon historical and predictive system usage metrics.

### BACKGROUND

Redundant Array of Independent Disk (“RAID”) is a data storage virtualization technology in which multiple physical storage disks are combined into one or more logical units in order to provide data protection in the form of data redundancy, improve system performance, and or for other reasons. By definition, a RAID system is comprised of multiple storage disk drives. It has been noted in the past that, in a RAID environment, it can be beneficial to provide a distributed network of storage elements in which the physical capacity of each drive is split into a set of equal sized logical splits, which are individually protected within the distributed network of storage elements using separate RAID groups. See e.g., U.S. Pat. No. 9,641,615 entitled “Allocating RAID storage volumes across a distributed network of storage elements,” granted on May 2, 2017 to Robins et al., the entire contents of which are hereby incorporated by reference.

Using RAID, data is distributed across the multiple drives according to one or more RAID levels, e.g., RAID-1-RAID-6, RAID 10, etc., or variations thereof, each defining different schemes providing various types and/or degrees of reliability, availability, performance or capacity. Many RAID levels employ an error protection scheme called parity, which may be considered a form of erasure encoding. In a data storage system in which RAID is employed, physical storage devices may be grouped into RAID groups according to a particular RAID schema employed.

In conventional data storage systems deployed with fixed RAID groups, expanding capacity of the storage system often requires adding a group of physical storage drives (i.e., “disk drives”) with the size (i.e., having a number of drives) defined by the specific RAID type, such as 4, 8, 23 etc. For example, RAID-6 requires a minimum of four disk drives. To expand storage capacity on a RAID-6-configured system, either four or more disk drives need to be added as a new RAID group, or one or more disk drives would need to be added to one of the existing RAID groups on the system. In situations where a user needs more storage than currently available, but not necessarily the additional capacity offered by four disk drives, the current capacity expansion systems and methods are inefficient and costly. It is, therefore, desirable to provide systems and methods that enable a user to add one or more drives into an existing RAID array based upon historic and predictive system utilization.

### SUMMARY

The following Summary and the Abstract set forth at the end of this application are provided herein to introduce some concepts discussed in the Detailed Description below. The Summary and Abstract sections are not comprehensive and are not intended to delineate the scope of protectable subject matter that is set forth by the claims presented below. All examples and features mentioned below can be combined in any technically possible way.

Methods, systems, and products disclosed herein use system utilization metrics to optimize RAID performance. Specifically, our systems, methods, and products make determinations regarding: (1) when to add additional storage; (2) how much additional storage to add; and (3) how to achieve system rebalance. The automated features of embodiments, optimize system performance, while simultaneously reducing cost and enhancing efficiency.

In some embodiments we disclose a method for a data storage system including a memory and a plurality of existing physical storage devices, each existing physical storage device logically divided into a plurality of split address spaces, a method comprising: monitoring a total capacity value for the existing plurality of physical storage devices to determine if the total capacity value exceeds a utilization limit, wherein: if the total capacity value exceeds the utilization limit, determining when the total capacity value will exceed a critical capacity limit; and if the total capacity value will exceed the critical capacity limit within a system performance evaluation period, adding at least one additional physical storage device to the data storage system; storing a data growth rate in the memory; and storing a plurality of data access rates in the memory, wherein the plurality of data access rates are correlated with a plurality of data blocks located in a plurality of splits in the plurality of existing physical storage device. In terms of logical division, non-volatile memory express (NVMe) drives allow a user to explicitly subdivide the drive's physical capacity into multiple logical “namespaces,” each having a logical block address (“LBA”) space, which is a portion of the entire drive. Whereas, with an implicit address space splitting, the data storage system is aware of the “splits” but the physical drive itself is not. Embodiments herein can employ either type of division.

In alternate embodiments, we disclose a system comprising: a plurality of existing physical storage devices, each existing physical storage device logically divided into a plurality of split address spaces; one or more processors; a memory comprising code stored thereon that, when executed, performs a method comprising: monitoring a total capacity value for the existing plurality of physical storage devices to determine if the total capacity value exceeds a utilization limit, wherein: if the total capacity value exceeds the utilization limit, determining when the total capacity value will exceed a critical capacity limit; and if the total capacity value will exceed the critical capacity limit within a system performance evaluation period, adding at least one additional physical storage device to the data storage system; storing a data growth rate in the memory; and storing a plurality of data access rates in the memory, wherein the plurality of data access rates are correlated with a plurality of data blocks located in a plurality of splits in the plurality of existing physical storage device. In terms of logical division, non-volatile memory express (NVMe) drives allow a user to explicitly subdivide the drive's physical capacity into multiple logical “namespaces,” each having a logical block address (“LBA”) space, which is a portion of the entire drive. Whereas, with an implicit address space splitting, the data storage system is aware of the “splits” but the physical drive itself is not. Embodiments herein can employ either type of division.

In yet alternate embodiments, we disclose a non-transitory computer readable storage medium having software stored thereon for a data storage system including a plurality of first physical storage devices, each first physical storage device logically divided into a plurality of first split address spaces, the software comprising: executable code that monitors a total capacity value for the existing plurality of physical storage devices to determine if the total capacity value exceeds a utilization limit, wherein: if the total capacity value exceeds the utilization limit, determining when the total capacity value will exceed a critical capacity limit; and if the total capacity value will exceed the critical capacity limit within a system performance evaluation period, adding at least one additional physical storage device to the data storage system; executable code that stores a data growth rate in the memory; and executable code that stores a plurality of data access rates in the memory, wherein the plurality of data access rates are correlated with a plurality of data blocks located in a plurality of splits in the plurality of existing physical storage device. In terms of logical division, non-volatile memory express (NVMe) drives allow a user to explicitly subdivide the drive's physical capacity into multiple logical “namespaces,” each having a logical block address (“LBA”) space, which is a portion of the entire drive. Whereas, with an implicit address space splitting, the data storage system is aware of the “splits” but the physical drive itself is not. Embodiments herein can employ either type of division.

### BRIEF DESCRIPTION OF THE DRAWINGS

Objects, features, and advantages of embodiments disclosed herein may be better understood by referring to the following description in conjunction with the accompanying drawings. The drawings are not meant to limit the scope of the claims included herewith. For clarity, not every element may be labeled in every figure. The drawings are not necessarily to scale, emphasis instead being placed upon illustrating embodiments, principles, and concepts. Thus, features and advantages of the present disclosure will become more apparent from the following detailed description of exemplary embodiments thereof taken in conjunction with the accompanying drawings in which:

FIG. 1 is a block diagram illustrating an example of a system according to embodiments of the system described herein.

FIG. 2A is a block diagram illustrating an example of a data storage system according to embodiments of the system described herein.

FIG. 2B is a representation of logical internal communications between directors and memory of the data storage system of FIG. 2A according to embodiments of the system described herein.

FIG. 3 is a schematic diagram showing a storage device including thin devices and data devices in connection with an embodiment of the system described herein.

FIG. 4 is a flow chart showing exemplary steps for embodiments disclosed herein.

FIG. 5 is a schematic illustration of a data storage system according to embodiments herein.

### DETAILED DESCRIPTION

Referring now to the figures of the drawings, the figures comprise a part of this specification and illustrate exemplary embodiments of the described system. It is to be understood that in some instances various aspects of the system may be shown schematically or may be shown exaggerated or altered to facilitate an understanding of the system. Additionally, method steps disclosed herein can be performed within a processor, a memory, a computer product having computer code loaded thereon, and the like.

Described herein is a system and methods for flexibly expanding the storage capacity of a data storage system by adding a single disk drive (i.e., “physical storage device”) or any number of disk drives to an existing storage system without the need to reconfigure existing erasure encoding groups (e.g., RAID groups) of the system. As used herein, an “erasure encoding group” (e.g., a RAID group) is a group of physical storage devices, or slices thereof, grouped together, and defined as a group, to provide data protection in the form of data redundancy in accordance with an error protection scheme, for example, a RAID level or a variation thereof.

The physical storage devices of a data storage system may be divided into a plurality of slices, where a “slice” is a contiguous sequential set of logical or physical block addresses of a physical device, and each slice may be a member of an erasure encoding group, e.g., a RAID group. Thus, unlike conventional RAID systems in which the members of the RAID group are physical storage devices in their entireties, in embodiments herein, the members of a RAID group, or another type of erasure encoding group, may be slices of physical storage devices.

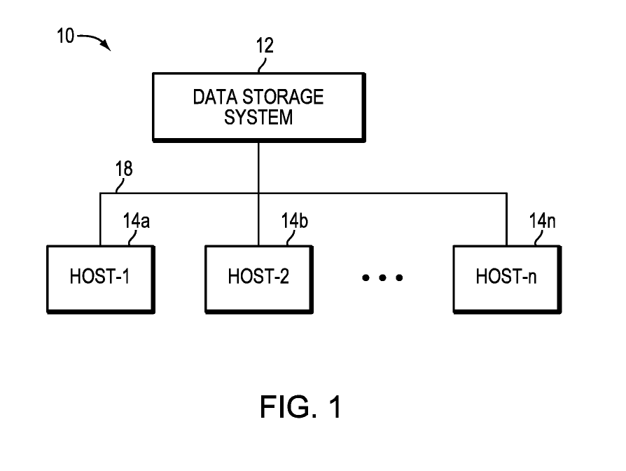

Referring now to FIG. 1, shown is an example of an embodiment of a system 10 according to some embodiments of the system described herein. The system 10 includes a data storage system 12 connected to host systems 14a-14n through communication medium 18. In this embodiment of the system 10, the N hosts 14a-14n may access the data storage system 12, for example, in performing input/output (I/O) operations or data requests. The communication medium 18 may be any one or more of a variety of networks or other type of communication connections as known to those skilled in the art. The communication medium 18 may be a network connection, bus, and/or other type of data link, such as a hard-wire or other connections known in the art. For example, the communication medium 18 may be the Internet, an intranet, network or other wireless or other hardwired connection(s) by which the host systems 14a-14n may access and communicate with the data storage system 12, and may also communicate with others included in the system 10.

Each of the host systems 14a-14n and the data storage system 12 included in the system 10 may be connected to the communication medium 18 by any one of a variety of connections as may be provided and supported in accordance with the type of communication medium 18. The processors included in the host computer systems 14a-14n may be any one of a variety of proprietary or commercially available single or multi-processor system, such as an Intel-based processor, or other type of commercially available processor able to support traffic in accordance with each particular embodiment and application.

It should be appreciated that the particulars of the hardware and software included in each of the components that may be included in the data storage system 12 are described herein in more detail, and may vary with each particular embodiment. Each of the host computers 14a-14n and data storage system may all be located at the same physical site, or, alternatively, may also be located in different physical locations. Communication media that may be used to provide the different types of connections between the host computer systems and the data storage system of the system 10 may use a variety of different communication protocols such as SCSI, ESCON, Fibre Channel, iSCSI, or GIGE (Gigabit Ethernet), and the like. Some or all of the connections by which the hosts and data storage system 12 may be connected to the communication medium 18 may pass through other communication devices, such as switching equipment, a phone line, a repeater, a multiplexer or even a satellite.

Each of the host computer systems may perform different types of data operations in accordance with different tasks and applications executing on the hosts. In the embodiment of FIG. 1, any one of the host computers 14a-14n may issue a data request to the data storage system 12 to perform a data operation. For example, an application executing on one of the host computers 14a-14n may perform a read or write operation resulting in one or more data requests to the data storage system 12.

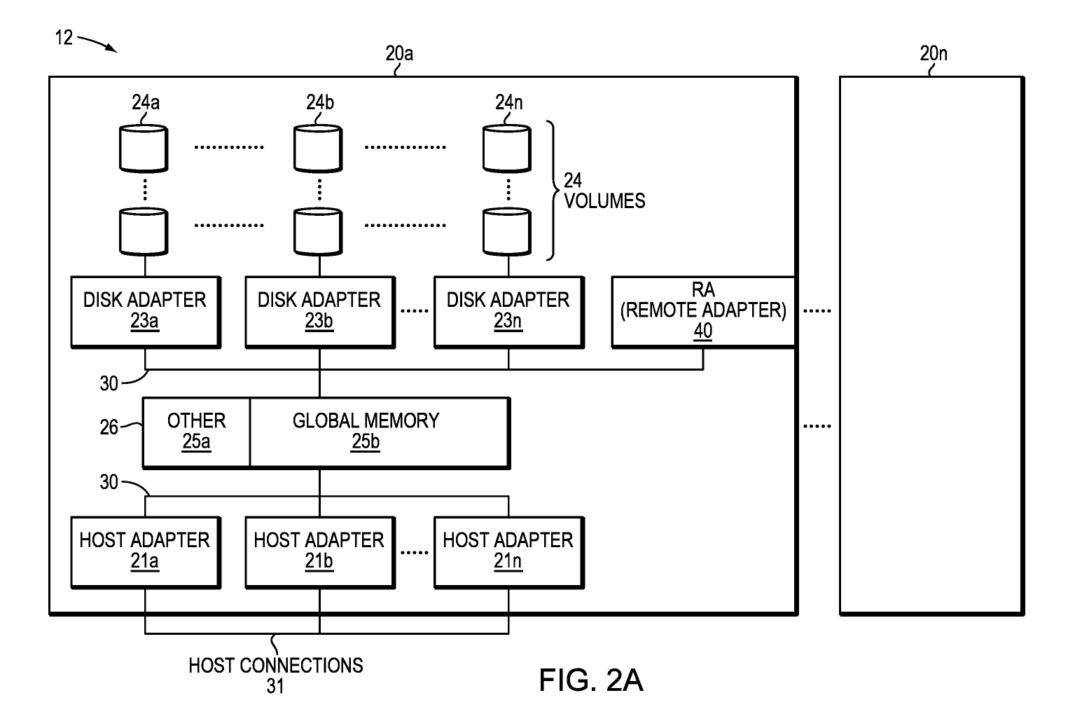

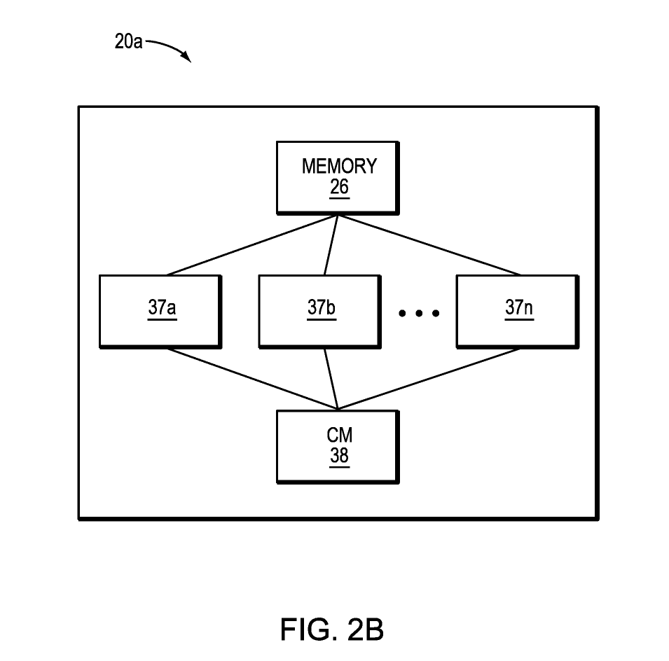

Referring now to FIG. 2A, shown is an example of an embodiment of the data storage system 12 that may be included in the system 10 of FIG. 1. Included in the data storage system 12 of FIG. 2A are one or more data storage systems 20a-20n as may be manufactured by a variety of vendors. Each of the data storage systems 20a-20n may be inter-connected (not shown). Additionally, the data storage systems may also be connected to the host systems through any one or more communication connections 31 that may vary with each particular embodiment and device in accordance with the different protocols used in a particular embodiment.

The type of communication connection used may vary with certain system parameters and requirements, such as those related to bandwidth and throughput required in accordance with a rate of I/O requests as may be issued by the host computer systems, for example, to the data storage system 12. In this example, as described in more detail in following paragraphs, reference is made to the more detailed view of element 20a. It should be noted that a similar more detailed description also may apply to any one or more of the other elements, such as 20n, but have been omitted for simplicity of explanation. It should also be noted that an embodiment may include data storage systems from one or more vendors. Each of 20a-20n may be resources included in an embodiment of the system 10 of FIG. 1 to provide storage services to, for example, host computer systems.

Each of the data storage systems, such as 20a, may include a plurality of data storage devices (e.g., physical non-volatile storage devices), such as disk devices or volumes, for example, in an arrangement 24 consisting of n rows of disks or volumes 24a-24n. In this arrangement, each row of disks or volumes may be connected to a disk adapter (“DA”) or director responsible for the backend management of operations to and from a portion of the disks or volumes 24. In the system 20a, a single DA, such as 23a, may be responsible for the management of a row of disks or volumes, such as row 24a.

System 20a also may include a fabric that enables any of disk adapters 23a-23n to access any of disks or volumes 24-24N, in which one or more technologies and/or protocols (e.g., NVMe or NVMe-oF) may be employed to communicate and transfer data between the DAs and the disks or volumes. The system 20a may also include one or more host adapters (“HAs”) or directors 21a-21n. Each of these HAs may be used to manage communications and data operations between one or more host systems and the global memory. In an embodiment, the HA may be a Fibre Channel Adapter or other type of adapter which facilitates host communication.

Also shown in the storage system 20a is an RA or remote adapter 40. The RA may be hardware including a processor used to facilitate communication between data storage systems, such as between two of the same or different types of data storage systems.

One or more internal logical communication paths may exist between the DAs, the RAs, the HAs, and the memory 26. An embodiment, for example, may use one or more internal busses and/or communication modules. For example, the global memory portion 25b may be used to facilitate data transfers and other communications between the DAs, HAs and RAs in a data storage system. In one embodiment, the DAs 23a-23n may perform data operations using a cache that may be included in the global memory portion 25b, for example, in communications with other disk adapters or directors, and other components of the system 20a. The other portion 25a is that portion of memory that may be used in connection with other designations that may vary in accordance with each embodiment.

It should be generally noted that the elements 24a-24n denoting data storage devices may be any suitable physical storage device such as a rotating disk drive, flash-based storage, 3D XPoint (3DXP) or other emerging non-volatile storage media and the like, which also may be referred to herein as “physical storage drives,” “physical drives” or “disk drives.” The particular data storage system as described in this embodiment, or a particular device thereof, such as a rotating disk or solid-state storage device (e.g., a flash-based storage device), should not be construed as a limitation. Other types of commercially available data storage systems, as well as processors and hardware controlling access to these particular devices, may also be included in an embodiment.

In at least one embodiment, write data received at the data storage system from a host or other client may be initially written to cache memory (e.g., such as may be included in the component designated as 25b) and marked as write pending. Once written to cache, the host may be notified that the write operation has completed. At a later point in time, the write data may be de-staged from cache to the physical storage device, such as by a DA.

Host systems provide data and access control information through channels to the storage systems, and the storage systems may also provide data to the host systems also through the channels. The host systems do not address the disk drives of the storage systems directly, but rather access to data may be provided to one or more host systems from what the host systems view as a plurality of logical devices, logical volumes or logical units (LUNs). The LUNs may or may not correspond to the actual disk drives. For example, one or more LUNs may reside on a single physical disk drive.

Data in a single storage system may be accessed by multiple hosts allowing the hosts to share the data residing therein. The HAs may be used in connection with communications between a data storage system and a host system. The RAs may be used in facilitating communications between two data storage systems. The DAs may be used in connection with facilitating communications to the associated disk drive(s) and LUN(s) residing thereon.

Referring to FIG. 2B, shown is a representation of the logical internal communications between the directors and memory included in a data storage system according to some embodiments of the invention. Included in FIG. 2B is a plurality of directors 37a-37n coupled to the memory 26. Each of the directors 37a-37n represents one of the HAs, RAs, or DAs that may be included in a data storage system. In an embodiment disclosed herein, there may be up to sixteen directors coupled to the memory 26. Other embodiments may use a higher or lower maximum number of directors that may vary.

The representation of FIG. 2B also includes an optional communication module (CM) 38 that provides an alternative communication path between the directors 37a-37n. Each of the directors 37a-37n may be coupled to the CM 38 so that any one of the directors 37a-37n may send a message and/or data to any other one of the directors 37a-37n without needing to go through the memory 26. The CM 38 may be implemented using conventional MUX/router technology where a sending one of the directors 37a-37n provides an appropriate address to cause a message and/or data to be received by an intended receiving one of the directors 37a-37n. In addition, a sending one of the directors 37a-37n may be able to broadcast a message to all of the other directors 37a-37n at the same time.

In an embodiment of a data storage system in accordance with techniques herein, components such as HAs, DAs, and the like may be implemented using one or more “cores” or processors each having their own memory used for communication between the different front end and back end components rather than utilize a global memory accessible to all storage processors.

It should be noted that although examples of techniques herein may be made with respect to a physical data storage system and its physical components (e.g., physical hardware for each HA, DA, HA port and the like), techniques herein may be performed in a physical data storage system including one or more emulated or virtualized components (e.g., emulated or virtualized ports, emulated or virtualized DAs or HAs), and also a virtualized or emulated data storage system including virtualized or emulated components.

In some embodiments of the system described herein, the data storage system as described in relation to FIGS. 1-2A may be characterized as having one or more logical mapping layers in which a logical device of the data storage system is exposed to the host whereby the logical device is mapped by such mapping layers of the data storage system to one or more physical devices. Additionally, the host also may have one or more additional mapping layers so that, for example, a host side logical device or volume is mapped to one or more data storage system logical devices as presented to the host.

Systems, methods, and computer program products disclosed herein could be executed on architecture similar to that depicted in FIGS. 1-2B. For example, method steps could be performed by processors. Similarly, global memory 26 could contain computer executable code sufficient to orchestrate the steps described and claimed herein. Likewise a computer program product internal to storage device 30 or coupled thereto could contain computer executable code sufficient to orchestrate the steps described and claimed herein.

A redundant array of independent disks (RAID) enables expansion of storage capacity by combining many small disks rather than a few large disks. RAID is generally not necessary for baseline performance and availability, but it might provide advantages in configurations that require extreme protection of in-flight data. RAID can be implemented by hardware, software, or a hybrid of both. Software RAID uses a server's operating system to virtualize and manage the RAID array. With Cloud Servers and Cloud Block Storage, you can create and use a cloud-based software RAID array.

In a storage system, each solid state drive (“SSD”) is divided into logical slices, which we refer to as “splits.” Splits typically have uniform capacity and specific LBA ranges. Splits are managed as if they were logical drives. They are used in redundancy schemes such as (n+k) RAID, erasure coding or other forms of redundancy schemes, where n represents the required number of splits without data being unavailable or lost, and k represent the number of parity or redundant splits. When a new drive is added to the system, it can be split in the same way as the rest of the drives in the system have been split. For embodiments in a RAID Cloud having the same physical capacity, the same number of splits per drive could be created (1/Nth of the drive's capacity). In alternate embodiments, however, the split size could be fixed, which would allow for different numbers of splits per drive to be created. In this way, the system could intermix drives of different physical capacity points in the same RAID Cloud.

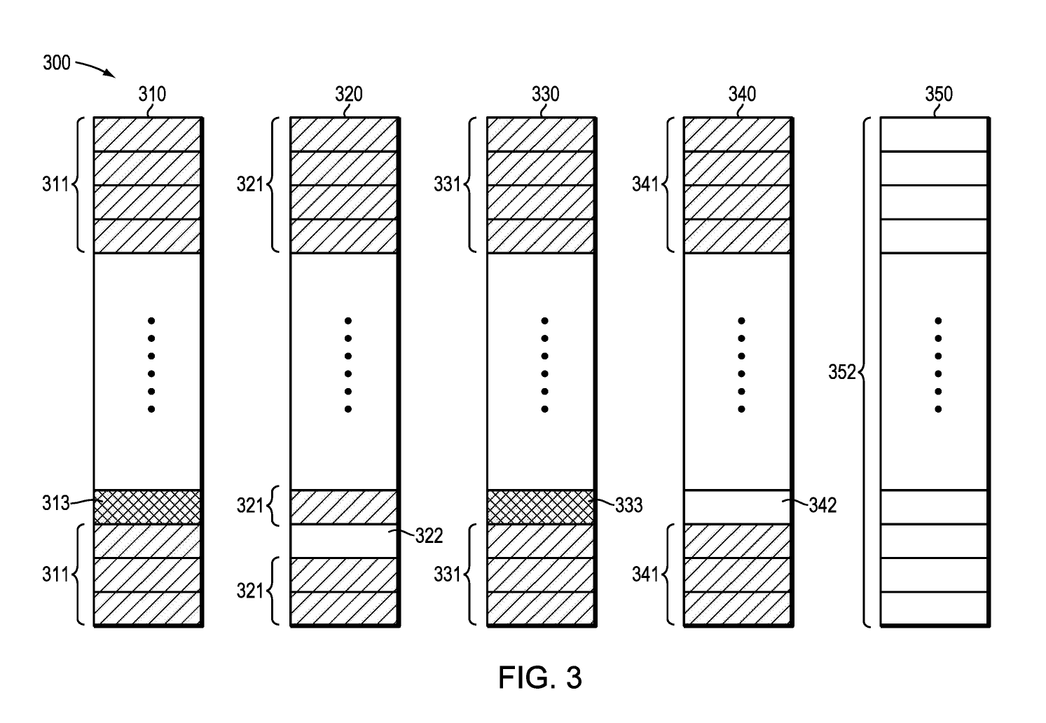

In order to illustrate these concepts, we show FIG. 3, which depicts an illustrative RAID group 300. In some embodiments, the RAID group 300 is a RAID cloud. Accordingly, we use these terms interchangeably throughout. In the state in which it is drawn, the RAID cloud 300 is currently using four storage drives, namely storage drives 310, 320, 330, and 340. In addition, RAID cloud 300 has an unused drive 350 available for future use. Although we show five total drives, this depiction is illustrative and not intended to be limiting. The number of drives that could be used within RAID cloud 300 is limitless.

In embodiments, the RAID level for RAID cloud 300 could be RAID 5. In alternate embodiments, the RAID level could be RAID 1, RAID 6, RAID 10, or any conceivable RAID level, RAID group size, or other erasure coding-based protection scheme.

Each drive 310, 320, 330, 340, and 350 is divided into multiple splits based on logical block address (“LBA”) range. The number of splits can vary in alternate embodiments. One exemplary RAID cloud 300 could divide drives 310, 320, 330, 340, and 350 into 64 splits. We use a 64-split drive as exemplary and not limiting in the sense that RAID Cloud selection of the number of splits per drive is almost unbounded, i.e., from 1 split covering the entire drive's physical capacity, which is physical RAID provisioning, to theoretically 1 split per single drive Logical Block Address.

Splits, instead of drives, are used to form RAID groups across drives 310, 320, 330, 340, and 350 across drives in a cloud.

With respect to system capacity, the four drives 310, 320, 330, and 340 of RAID cloud 300 are nearly full. Specifically, splits having cross-hatching are full. Those shown in solid are unusable, which could mean lost, defective, non-existent and the like. And those shown unshaded are spares. Specifically, all of the splits in drive 310 are full splits 311, except for lost split 313. Similarly, drive 320 contains full splits 321 and spare split 322. Drive 330 contains full splits 331 and one lost split 333. Drive 340 contains full splits 341 and one spare split 342.

In this situation, it would be both common and prudent for the data storage customer or manager to desire to add storage capacity. Toward that end, we show unused drive 350, which is comprised of all spare splits 352. As previously stated, adding storage capacity lacked architectural flexibility. For example, FIG. 3 shows adding a single unused drive 350. In many real-world scenarios, however, system expansion could only be accomplished by adding larger numbers of drives. In traditional RAID protection, an (n+k) protected system comprises n+k drives. The straightforward way to add capacity to this system is to add another n+k drives to it. This type of addition represents a large capacity addition. In many instances, however, users would prefer adding capacity in smaller increments. For simplicity, we use the example of adding one more drive. In that case, we have to provide protection across n+k+1 drives. The options are: (1) change the protection type to m+k, where m=n+1; or (2) redistribute existing n+k protection pieces across n+k+1 drives. Neither of these options provides an efficient, cost effective means of adding small increments of capacity.

As those of skill in the art will recognize, it is common within RAID storage systems to move data depending upon how frequently the data is accessed. The concept of data migration within a RAID storage system is beyond the scope of this disclosure, but it nonetheless underlies methods and teachings disclosed herein. Specifically, and with regard to FIG. 3, the question will become, at what point in time is it most efficient to begin to move data from the splits in drives 310, 320, 330, and 340 to the splits in drive 350? This question leads to several others such as, which data should be moved? In what order should specific data blocks be moved? What can be done to rebalance the data distribution within the data storage system to optimize performance? Embodiments disclosed herein address these questions by providing systems, methods, and products that analyze historic system performance in order to optimize future system performance.

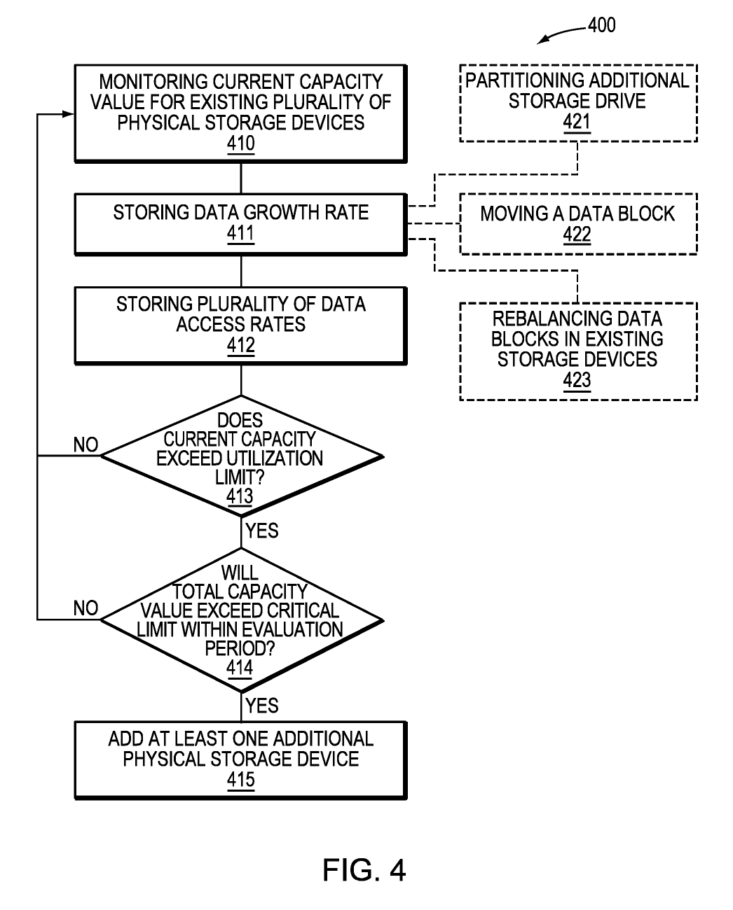

FIG. 4 depicts steps according to methods herein for adding storage space to an existing RAID group 300 or RAID cloud 300. We disclose a method for facilitating metrics driven expansion 400 of capacity in a solid state storage system. As a preliminary matter, the data storage system embodiments disclosed herein are customizable. Customers can set various triggering thresholds that affect when and how additional data storage capacity can be added to the data storage system. In some embodiments, users/customers can specify a warning capacity utilization limit (U_{w}), a critical capacity utilization limit (U_{c}), and a system performance evaluation period (Tₛ).

For illustrative purposes, and without limitation, we illustrate the method for facilitating metrics driven expansion using a data storage system 12 is comprised often (10) 8 TB physical drives, having a total capacity (Cₜ) of 80 TB. If the customer sets the utilization limit, U_{w}, to 80%, the critical capacity limit, U_{c}, to 90%, and the system performance evaluation period, Tₛ, to three (3) months, the following method steps would be performed. First, we monitor 411 a current capacity utilization value (U_{c}) to determine how much data is being stored in the data storage system 12. In addition, the method comprises storing 411 a data growth rate, Dᵤ, which is percentage of growth of the data capacity utilization as a function of time. For example, if at time t₁, the current capacity utilization, U_{c1}, was 50% (40 TB out of 80 TB), and if at time t₂, which was one month later, the current capacity utilization, U_{c2}, was 62.5% (50 TB out of 80 TB), the data growth rate Dᵤ would be calculated as follows:

Dᵤ=(U_{c2}−U_{c1})/(t₂−t₁)

Substituting in the hypothetical values of 50% for U₁ and 62.5% for U_{c2}, and assuming that it is 3 months between t₁ and t₂, we arrive at a data growth rate, Dᵤ, of 12.5% per 3 months. This data growth rate, Dᵤ, will be stored 411 as the method embodiments are executed.

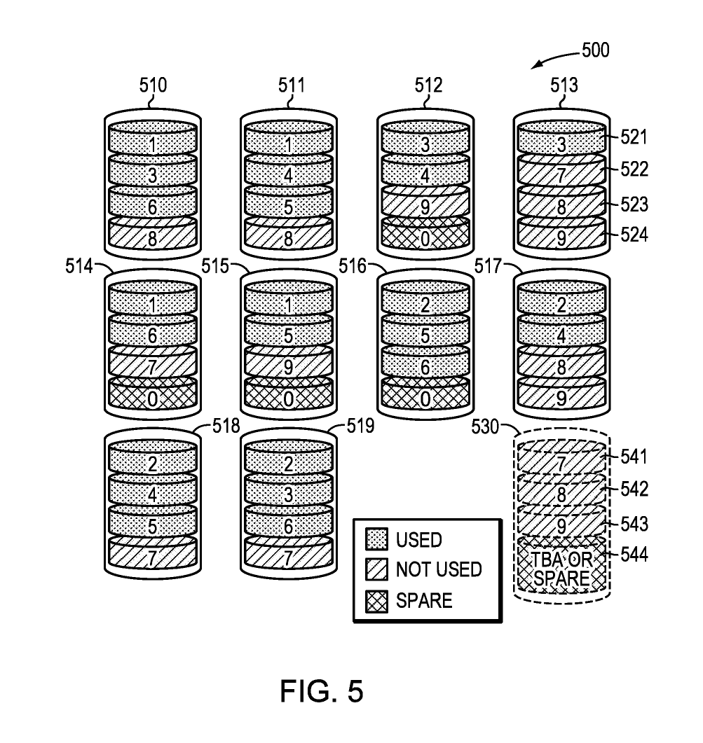

In addition, method embodiments store 412 a plurality of data access rates for data blocks stored within the data storage system 12. Reference is made to FIG. 5 to illustrate this concept. The data storage system 500 of FIG. 5 is comprised of a plurality of existing physical storage devices 510-519. The existing physical storage devices 510-519 each comprise four (4) splits. For simplicity, we show splits 521-524 in existing physical storage device 513 with the understanding that each of the plurality of existing physical storage devices 510-519 has similar splits located therein. In this embodiment, data storage system 500 could be a RAID cloud-based system having a plurality of SSDs.

Data blocks, which in exemplary embodiments could consist of allocation units of 256 drive LBAs, are depicted within each of the splits as numerical values. For a relevant embodiment, “data blocks” are sub-units allocated from split's address range. In other embodiments, however, “data blocks” may be effectively the size of the split itself and may not practically exist on their own. Those skilled in the art will recognize that different numerical values indicate different data blocks. RAID group redundancy is shown by using the same numerical value within a split. Those of skill in the art will also recognize that data block size can vary generally from a single drive LBA up to the entire split size. In some preferred embodiments, implementations would likely utilize data block allocation sizes that are powers of 2, and which are integer multiples of underlying media storage preferred alignment sizes, e.g., 4 KB, 8 KB, 64 KB, and so forth. In FIG. 5, we show three data blocks having a low data access rate. Namely, data blocks 7, 8, and 9, one or more of which appear in existing physical storage devices 510, 511, 512, 513, 514, 515, 517, 518, and 519 have a data access rate that is low enough to designate these data blocks as being “not used” or cold.

Referring again to FIG. 4, the method for facilitating metrics driven expansion additionally comprises determining 413 if the current capacity Cc exceeds a utilization limit U_{w}. If the current capacity does exceed a utilization limit U_{w}, the method determines 414 if the data storage system will exceed a critical capacity limit U_{c} within the system performance evaluation period, Tₛ. If the current capacity does not exceed a utilization limit U_{w}, no action is taken until the next system evaluation is performed. If the critical capacity limit will be exceeded within the system performance evaluation period, Tₛ, the method adds 415 at least one additional physical storage device 530 to the data storage system 500.

If an additional physical storage device 530 is added 415, in some embodiments, the additional physical storage device 530 could be partitioned 421 into splits. In additional embodiments, it may be it may be advantageous to move 422 one or more data blocks 521-524 to additional physical storage device 530. In yet alternate embodiments, it may be beneficial to rebalance 423 data blocks stored in existing physical storage devices 510-519 according to myriad user preferences.

For example, rebalancing 423 could involve moving hot (or most active) data to the at least one additional storage devices 530. Alternatively, a user could chose to move cold (idle or least active) data to the at least one additional storage devices 530. In some embodiments, the decisions of which data blocks to move to newly added splits 541-545 could be determined by evaluating data access rates. In additional embodiments, determining when to move data blocks to newly added splits 541-544 could be determined by examining read or write patterns, which could be part of the data access rate information stored 412 by the methods disclosed herein.

Although exemplary figures depict RAID cloud storage by virtue of the fact that different RAID groups, as indicated by the numbers 1-9 depicted in existing storage devices 510-519, are collocated within an individual physical storage device 510-519. In alternate embodiments, however, the teachings herein could be utilized in non-cloud based storage systems.

In some embodiments, it may be advantageous to rebalance 423 data within the data storage system even if additional storage has not been added 415. In some embodiments, there could be a proactive method of rebalancing 423 data, which means a system-initiated rebalance 423. In alternate embodiments, rebalancing 423 could be reactive, meaning host initiated. Although proactive rebalancing 423 is faster, the tradeoff is a performance penalty, which is not experienced with reactive rebalancing 423. In some embodiments, rebalancing can be performed if the data storage system 500 has very low utilization U_{c} or it contains mainly cold data. In this instance, a proactive rebalance could be performed. In some embodiments, the user could set a threshold value for how low the utilization value U_{c} should be before initiating a proactive rebalance 423.

In alternate embodiments, if the data storage system 500 has a large amount of cold data, as determined by the measurement of data access rates 412, a data rebalance could be performed wherein cold data are proactively rebalanced 423 and hot data are reactively rebalanced 423. Alternatively, if a data storage system 500 has high utilization U_{c} and contains a substantial amount of hot data, a reactive rebalance 423 could be performed. In any of these scenarios, users could determine threshold values for how much hot or cold data would trigger a proactive or reactive rebalance 423, respectively.

Throughout the entirety of the present disclosure, use of the articles “a” or “an” to modify a noun may be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Various changes and modifications of the embodiments shown in the drawings and described in the specification may be made within the spirit and scope of the present invention. Accordingly, it is intended that all matter contained in the above description and shown in the accompanying drawings be interpreted in an illustrative and not in a limiting sense. The invention is limited only as defined in the following claims and the equivalents thereto.

What is claimed is:

1. For a data storage system including a memory and a plurality of existing physical storage devices, each existing physical storage device logically divided, either explicitly or implicitly, into a plurality of split address spaces, a method comprising:
a. monitoring a total capacity value for the existing plurality of physical storage devices to determine if the total capacity value exceeds a utilization limit, wherein:
i. if the total capacity value exceeds the utilization limit, determining when the total capacity value will exceed a critical capacity limit; and
ii. if the total capacity value will exceed the critical capacity limit within a system performance evaluation period, adding at least one additional physical storage device to the data storage system;
b. storing a data growth rate in the memory; and
c. storing a plurality of data access rates in the memory, wherein the plurality of data access rates are correlated with a plurality of data blocks located in a plurality of splits in the plurality of existing physical storage device.

2. The method of claim 1 further comprising using the data growth rate to determine when the total capacity value will exceed the critical capacity limit.

3. The method of claim 1 further comprising partitioning the at least one additional physical storage drives into a plurality of additional split address spaces.

4. The method of claim 3 further comprising moving a data block among the plurality of data blocks stored in the plurality of split address spaces into a split within the plurality of additional split address spaces.

5. The method of claim 4 further comprising using the plurality of data access rates to determine when to copy the data block into the split within the plurality of additional split address spaces.

6. The method of claim 4 further comprising using the plurality of data access rates to determine which of a plurality of data blocks stored in the plurality of split address spaces to copy into the split within the plurality of additional split address spaces.

7. The method of claim 1 further comprising rebalancing the plurality of data blocks located in the existing physical storage devices by redistributing the plurality of data blocks among the existing physical storage devices and the additional physical storage device.

8. A system comprising:
a. a plurality of existing physical storage devices, each existing physical storage device logically divided, either explicitly or implicitly, into a plurality of split address spaces;
b. one or more processors;
c. a memory comprising code stored thereon that, when executed, performs a method comprising:
i. monitoring a total capacity value for the existing plurality of physical storage devices to determine if the total capacity value exceeds a utilization limit, wherein:
1. if the total capacity value exceeds the utilization limit, determining when the total capacity value will exceed a critical capacity limit; and
2. if the total capacity value will exceed the critical capacity limit within a system performance evaluation period, adding at least one additional physical storage device to the data storage system;
ii. storing a data growth rate in the memory; and
d. storing a plurality of data access rates in the memory, wherein the plurality of data access rates are correlated with a plurality of data blocks located in a plurality of splits in the plurality of existing physical storage device.

9. The system of claim 8 wherein the method further comprising using the data growth rate to determine when the total capacity value will exceed the critical capacity limit.

10. The system of claim 8 wherein the method further comprises partitioning the at least one additional physical storage drives into a plurality of additional split address spaces.

11. The system of claim 10 wherein the method further comprises moving a data block among the plurality of data blocks stored in the plurality of split address spaces into a split within the plurality of additional split address spaces.

12. The system of claim 11 wherein the method further comprises using the plurality of data access rates to determine when to copy the data block into the split within the plurality of additional split address spaces.

13. The system of claim 11 wherein the method further comprises using the plurality of data access rates to determine which of a plurality of data blocks stored in the plurality of split address spaces to copy into the split within the plurality of additional split address spaces.

14. The system of claim 8 wherein the method further comprises rebalancing the plurality of data blocks located in the existing physical storage devices by redistributing the plurality of data blocks among the existing physical storage devices and the additional physical storage device.

15. A non-transitory computer readable storage medium having software stored thereon for a data storage system including a plurality of first physical storage devices, each first physical storage device logically divided, either explicitly or implicitly, into a plurality of first split address spaces, the software comprising:
a. executable code that monitors a total capacity value for the existing plurality of physical storage devices to determine if the total capacity value exceeds a utilization limit, wherein:
i. if the total capacity value exceeds the utilization limit, determining when the total capacity value will exceed a critical capacity limit; and
ii. if the total capacity value will exceed the critical capacity limit within a system performance evaluation period, adding at least one additional physical storage device to the data storage system;
b. executable code that stores a data growth rate in the memory; and
c. executable code that stores a plurality of data access rates in the memory, wherein the plurality of data access rates are correlated with a plurality of data blocks located in a plurality of splits in the plurality of existing physical storage device.

16. The non-transitory computer readable storage medium of claim 15 further comprising executable code that uses the data growth rate to determine when the total capacity value will exceed the critical capacity limit.

17. The non-transitory computer readable storage medium of claim 15 further comprising executable code that partitions the at least one additional physical storage drives into a plurality of additional split address spaces.

18. The non-transitory computer readable storage medium of claim 17 further comprising executable code that moves a data block among the plurality of data blocks stored in the plurality of split address spaces into a split within the plurality of additional split address spaces.

19. The non-transitory computer readable storage medium of claim 17 further comprising executable code that uses the plurality of data access rates to determine when to copy the data block into the split within the plurality of additional split address spaces or which of a plurality of data blocks stored in the plurality of split address spaces to copy into the split within the plurality of additional split address spaces.

20. The non-transitory computer readable storage medium of claim 15 further comprising executable code that rebalances the plurality of data blocks located in the existing physical storage devices by redistributing the plurality of data blocks among the existing physical storage devices and the additional physical storage device.
